(19) United States
(12) Patent Application Publication
(10) Pub. No.: US 2003/0233319 A1
(43) Pub. Date: Dec. 18, 2003

(54) Electronic fund transfer participant risk management clearing

(76) Inventor: David Lawrence, New York, NY (US)

Correspondence Address: Clifford Chance US LLP, 200 Park Avenue, New York, NY, 10016, US

(21) Appl. No.: 10/459,258

(22) Filed: Jun. 11, 2003

Related U.S. Application Data
(63) Continuation-in-part of application No. 10/074,584, filed on Feb. 12, 2002.
Application No. 10/074,584 is a continuation-in-part of application No. 10/021,124, filed on Oct. 30, 2001.
Application No. 10/021,124 is a continuation-in-part of application No. 09/812,627, filed on Mar. 20, 2001.
(60) Provisional application No. 60/387,849, filed on Jun. 11, 2002.
(60) Provisional application No. 60/387,791, filed on Jun. 11, 2002.

(51) Int. Cl. G06F 17/60

(52) U.S. Cl. 705/39

(57) ABSTRACT

Methods and systems for managing risk related to transfer of funds. The method can be implemented in a computer system and indicating in the computer system that a person is a transaction participant according to the person's status as at least one of: a transaction originator; a transaction intermediary, a transaction recipient or a transaction beneficiary. Data can be gathered into the computer system generally related to one or more risk variables. Data can also be received relating details of a financial transaction. The received data can be structured to generally relate to one or more risk variables according to risk criteria. One or more reports can be generated which relate to risk due diligence wherein the report includes an indication that the transaction participant is associated with elevated risk and at least some of the structured data.

### CROSS REFERENCE TO RELATED APPLICATIONS

This application claims the benefit of the filing date of U.S. Provisional applications nos. 60/387,849 entitled “Jurisdiction Related Fund Transfer Risk Management”, filed Jun. 11, 2002 and 60/387,791 entitled “Electronic Fund Transfer Participant Risk Management Clearinghouse”, also filed Jun. 11, 2002. This application is a continuation-in-part of a prior application entitled “Risk Management Clearinghouse”, filed Feb. 12, 2002, and bearing the Ser. No. 10/074,584 which is a continuation-in-part of a prior application also entitled “Risk Management Clearinghouse” filed Oct. 30, 2001, and bearing the Ser. No. 10/021,124, which is also a continuation-in-part of a prior application entitled “Automated Global Risk Management” filed Mar. 20, 2001, and bearing the Ser. No. 09/812,627, all of which are relied upon and incorporated by reference.

### BACKGROUND

This invention relates generally to a method and system for facilitating the identification, investigation, assessment and management of legal, regulatory, financial and reputational risks (“Risks”). In particular, the present invention relates to a computerized system and method for banks, non-bank financial institutions and any other entity involved in financial transactions to access information compiled on a worldwide basis and relate such information to a risk variable, such as a political or geographic area involved in a wire transfer, wherein the information is conducive to quantifying and managing financial, legal, regulatory and reputational risk associated with the transaction.

Electronic transfer of money has become increasingly popular in the marketplace. For example, the U.S. Federal Reserve provides a funds transfer service as well as a securities related custodial and transfer service, generally referred to as “Fedwire”. The volume of transactions performed by Fedwire more than doubled since 1988 to over 112 million transactions in 2001. Sheer volume alone has made tracking a source and destination of funds a formidable task. The tracking of funds is further complicated by the increase in international movement of monies accelerated by globalization of markets and general technology advancements. However, even as the volume and complexity of wire transfers has increased, the importance of monitoring fund transfer transactions has also increased.

As money-laundering and related concerns have become vitally important public policy concerns, regulators have attempted to address these issues by imposing increasing formal and informal obligations upon financial institution. Government regulations authorize a broad regime of record-keeping and regulatory reporting obligations on covered Financial Institutions as a tool for the federal government to use to fight drug trafficking, money laundering, and other crimes. The regulations may require an industry participant to file currency and monetary instrument reports and to maintain certain records for possible use in tax, criminal and regulatory proceedings. Such a body of regulation is designed chiefly to assist law enforcement authorities in detecting when criminals are using a bank and other Financial Institution as an intermediary for, or to hide the transfer of funds derived from, criminal activity.

Obligations of Financial Institutions can include those imposed by the Department of the Treasury and the federal banking regulators which adopted suspicious activity report (“SAR”) regulations. SAR regulations can require that a Financial Institution file a SAR whenever the institution detects a known or suspected violation of federal law, or a suspicious transaction related to a money laundering activity or a violation of the Bank Secrecy Act (BSA). Such regulations can impose a variety of reporting obligations on a Financial Institution. Perhaps most broadly relevant to the present invention, they require an institution to report transactions aggregating to $5,000 that involve potential money laundering or violations if the Financial Institution, knows, suspects, or has reason to suspect that the transaction involves funds from illegal activities, is designed to disguise such funds, has no business or legitimate purpose, or is simply not the sort of transaction in which the particular customer would normally be expected to engage, and the institution knows of no reasonable explanation for the transaction after examining the available facts.

Federal regulators have made clear that the practical effect of these requirements is that Financial Institutions are subject to significant obligations to “know” their customer and to engage in adequate monitoring of transactions.

Related Risk can be multifaceted and far reaching. Generally, personnel do not have available a mechanism to provide real time assistance to assess a risk factor or otherwise qualitatively manage risk. In the event of a problem, it is often difficult to quantify to regulatory bodies, shareholders, newspapers and other interested parties, diligence exercised by the Financial Institution to properly identify and respond to risk factors. Absent a means to quantify good business practices and diligent efforts to contain risk, a Financial Institution may appear to be negligent in some respect.

General data services that are available to search news sources and other public information will accept a query and return a result. However, such services are not integrated into a risk management system and individual searches can be slow and results often times irrelevant. In addition, present data services return a flat response to a query submitted without any further data mining or scrubbing. The inefficiency of having to manually ascertain what terms should be searched and then submit a query that includes those terms makes presently available systems overbearing on a transaction by transaction basis. Also, over time, databases can accrue a wide range of inaccuracies and inconsistencies, such as a misspelled name, inverted text, missing fields, alternate spelling of key phrases, and other blemishes. Fixing faulty records by hand on a timeframe needed to perform risk management associated with a wire transfer may be impossible as well as expensive and could result in the introduction of even more errors.

What is needed is a method and system to draw upon information gathered globally and utilize the information to assist with risk management and due diligence related to wire transfers.

### SUMMARY

To alleviate problems inherent in the prior art, the present invention introduces systems and methods to facilitate ascertaining and managing Risks associated with a wire transfer of money.

Methods and systems for managing risk related to transfer of funds. The method can be implemented in a computer system and indicating in the computer system that a person is a transaction participant according to the person's status as at least one of: a transaction originator; a transaction intermediary, a transaction recipient or a transaction beneficiary. Data can be gathered into the computer system generally related to one or more risk variables. Data can also be received relating details of a financial transaction wherein the data received includes identification data for at least one transaction participant. The received data can be structured to generally relate to one or more risk variables according to risk criteria, wherein the risk criteria include at least one of: a position held by the transaction participant; a country in which the position is held; how long the position has been held; the veracity of previous dealings with persons from the country in which the position is held; the propensity of people in similar positions to execute unlawful transactions; the propensity of people in similar positions to execute unethical transactions; inclusion of the participant on a list indicating elevated risk; and the type of account. One or more reports can be generated which relate to risk due diligence wherein the report includes an indication that the transaction participant is associated with elevated risk and at least some of the structured data.

Other embodiments are directed to a computerized system for implementing various method steps described herein and a computer executable program code residing on a computer-readable medium, the program code comprising instructions for causing a computer to also implement the method steps described herein.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of some implementations of the present invention.

FIG. 2 is a block diagram overview of a communication system according to some embodiments of the present invention.

FIGS. 3-4 illustrate flow charts of various methods according to some embodiments of the present invention.

FIG. 5 is a representation of a portion of an information database according to some embodiments of the present invention.

FIG. 6 illustrates a flow chart of additional steps than can be implemented in some embodiments of the present invention.

FIG. 7 illustrates a graphical user interface that can be utilized with some embodiments of the present invention.

FIG. 8 is a tabular representation of a portion of an information database according to some embodiments of the present invention.

FIG. 9 is another tabular representation of a portion of a risk management database according to some embodiments of the present invention.

### DETAILED DESCRIPTION

The present invention includes a methods and systems for facilitating management of risk associated with electronic transfer of funds, such as a wire transfer or electronic document exchange (EDI).

A depository institution that maintains a reserve or clearing account with a Federal Reserve Bank may use Fedwire to send payments to, or receive payments from, other account holders directly. Other transfers can include SWIFT, FUNDS, CHIPS, National Automated Clearinghouse Association (NACHES) formatted transfers, or other electronic or wire transfer platform. Risk associated with maintaining such accounts, can include factors associated with financial risk, legal risk, regulatory risk and reputational risk. Financial risk includes factors indicative of monetary costs that a Financial Institution may be exposed to as a result of performing a particular transaction. Monetary costs can be related to fines, forfeitures, costs to defend an adverse position, lost revenue, or other related potential sources of expense. Regulatory risk includes factors that may cause the Financial Institution to be in violation of rules put forth by a regulatory agency, such as the Securities and Exchange Commission (SEC). Reputational risk relates to harm that a Financial Institution may suffer regarding its professional standing in the industry. A Financial Institution can suffer from being associated with a situation that may be interpreted as contrary to an image of honesty and forthrightness.

A financial institution can include bank and non-bank financial institutions, including: an investment bank; a merchant bank; a securities firm, any insured bank (as defined in section 3(h) of the Federal Deposit Insurance Act (12 U.S.C. 1813(h)); a commercial bank or trust company; a private banker; a credit union; a thrift institution; broker dealers securities and commodities trading firms; asset management companies, hedge funds, mutual funds, credit rating funds, securities exchanges and bourses, institutional and individual investors, law firms, accounting firms, auditing firms, or any institution the business which is engaging in financial activities as described in section 4(k) of the Bank Holding Act of 1956; a money services business; a telegraph company, a casino; a card club; a foreign bank or foreign financial agency; an entity that may be subject to legal and regulatory obligations associated with the USA PATRIOT Act, any agent, agency, branch or office of any person doing business in one or more of a commercial bank or trust; a private bank; a savings and loan association or a building and loan association; an insured institution as defined in section 401 of the National Housing Act; a savings bank, industrial bank or other thrift institution; a credit union; any organization chartered under the banking laws of any state and subject to the supervision of the bank supervisory authorities of a State; a bank organized under foreign law; a national banking association or corporation; hereinafter collectively referred to as “Financial Institution.” For the purposes of this document, a Financial Institution can also include any individual, a corporation, a partnership, a trust or estate, a joint stock company, an association, a syndicate, joint venture, or other unincorporated organization or group, an Indian Tribe and any entity cognizable as a legal personality involved in making or receiving an electronic payment or wire transfer.

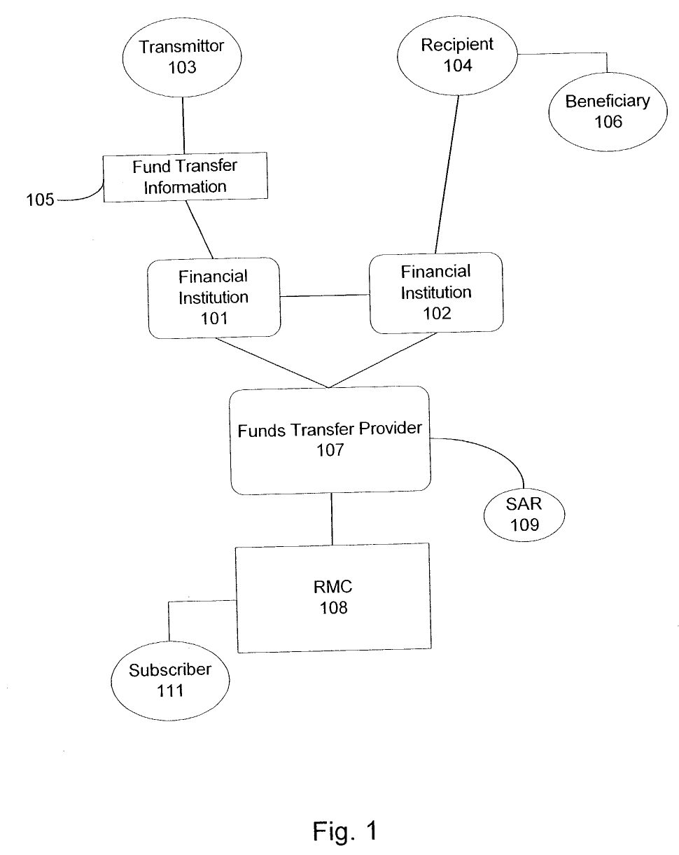

Referring now to FIG. 1 a block diagram of one embodiment of the present invention is illustrated. In addition to other services that an RMC system 108 may provide, such as those described in related documents, an RMC system 108 can facilitate management of risk associated with an wire transfer or other electronic transfer of funds. Embodiments can include, an RMC system 108 linked to a Funds Transfer Provider 107 such that the RMC system 108 can provide references and documentation relating to an originating jurisdiction and/or destination jurisdiction for each wire transfer conducted by the funds transfer institution. A transfer participant 103-104 can provide information relating to a transfer of funds 105 to a market entity 101-102 in order to implement a wire transfer, such as from a originator 103 to a recipient 104. In some embodiments, a recipient may be acting on behalf of a beneficiary 106. In such instances, the beneficiary can also be included in due diligence efforts and an RMC 108 inquiry.

A transfer participant 103-104 can include an individual, a business, a corporation, a government entity, a charity, a church, or any other entity cognizable as a legal personality involved in making or receiving an electronic payment or wire transfer or that may be involved in a transfer of funds. In addition, a transfer participant 103-104 can include an originator 103 of an electronic fund transfer supplying funds to another party, or a recipient of funds 104.

The fund transfer information 105 can include: information identifying the transfer participants 103-104 involved; an account number or other identifier of an account supplying funds to be transferred; an account number or other identifier of a recipient account; an address and/or other identifying information of a transfer participant originating a fund transfer 103, an address and/or other identifying information of a transfer participant receiving funds via a fund transfer; a country or other jurisdiction from which the fund transfer originates; a country or other jurisdiction that is a destination of the fund transfer, any intermediary jurisdictions that may be involved with the fund transfer; a transaction identification number; any annotations included in the fund transfer and any other information related to the transfer of funds.

A market entity 101-102 can include any entity that can initiate or consummate a wire transfer or other electronic transfer of funds, such as, for example, a bank branch, a depository Financial Institution (DPI), a correspondent bank, an agent of a service that provides money transfers, an internet based fund transfer provider, a member of an automated clearinghouse (ACH), a member of the Clearing House Interbank Payment System (CHIPS), or any other entity that can interact with a transfer participant 103-104 for the purpose of electronically transferring funds.

A Funds Transfer Provider 107 can include any entity with resources, facilities, authorizations or other factors required to effect an electronic transfer of funds. For example, a funds transfer institution can include a government entity, such as the U.S. Federal Reserve's Fedwire or a private institution, such as Western Union, CHIPS or SWIFT.

A Risk Management Clearinghouse (RMC) 108 can include any entity that gathers data, such as, for example, public data, and relates the data to risk variables for the purpose of managing risk associated with a risk variable. Embodiments can include a RMC 108 that structures, indexes, scrubs, mines or otherwise enhances data and/or data retrieval. Embodiments can also include a RMC 108 that provides a risk quotient or other valuation of an amount of risk. A risk quotient can relate, for example, to an amount of risk associated with: a particular risk variable, set of risk variables, transaction, institution, individual, jurisdiction, organization, entity or other risk subject.

Some embodiments can include a Financial Institution maintaining a record of each request, instruction or piece of advice received or given regarding any transaction resulting, or intended to result in the transfer of currency or other monetary instruments, funds, checks, investment securities, or credit. Some embodiments can also include a record of each advice, request, or instruction given to another Financial Institution or other person located within or without the United States, regarding a transaction intended to result in the transfer of funds, currency or other monetary instruments, checks, investment securities, or credit.

Risk related criteria, which a Financial Institution can record and forward to a RMC system 108 can include informational data, such as, for example: the name and address of the originator 103, transmitter, recipient 104, beneficiary, intermediary or other associated party; an amount of a payment order; or other money transfer; an execution date of a payment order or other money transfer; payment instructions received from an originator or intermediary related to the payment order or other money transfer; the identity of the beneficiary's or recipient's bank; and any account numbers related to the transaction; any other specific identifier of an originator or beneficiary; if a payment order is made in person, any verification of the identity of the person placing the payment order.

If a participant Financial Institution accepts a payment order, the Financial Institution can obtain and retain data descriptive of the transaction, such as, for example, a record of the name and address of an originator, transmitter, intermediary, recipient and/or beneficiary, (Transaction Party) a type of identification reviewed for any person, a number associated with an identification document (e.g., driver's license), a record of the person's taxpayer identification number (e.g., social security or employer identification number, alien identification number or passport number) a country of issuance of an identifying document, or a notation in the record of the lack thereof.

Similarly, if a Financial Institution becomes associated with a payment order or other money transfer, such as, by performing the role of originating bank, intermediary, or recipient bank, and the transaction is not made in person some embodiments can include creating and maintaining similar records descriptive of any or all parties involved with or otherwise associated with the transaction.

Some embodiments can also include tracking each jurisdiction, country, sovereign area, nation or other political designation involved in each step of the transaction. For example, for any or each transaction, an origination and designation or recipient jurisdiction, as well as the jurisdiction of any intermediary jurisdiction, can be determined and forwarded to a RMC system 108 to conduct a risk management search.

Similarly, embodiments can include tracking an address associated with a wire transfer, electronic payment or other automated transfer of funds. Addresses associated with any parties involved with, or related to a transaction can be received and stored in a data structure. The addresses can also be forwarded to a RMC system 108. The RMC system 108 can search the addresses and relate the addresses to any known or related risk factors.

In another aspect, some embodiments can include establishing and maintaining records related to any or all Transaction Parties, such as a transaction originator 103, transmitter, intermediary, recipient 104, beneficiary, or other related party. For example, for any payment or other transaction, if the proceeds are delivered in person to a beneficiary or its representative or agent, the beneficiary's bank can verify the identity of a person receiving the proceeds and obtain and retain a record of the name and address, the type of identification reviewed, the number of an identification document (e.g., driver's license), as well as a record of the person's taxpayer identification number (e.g., social security or employer identification number) or, if none, alien identification number or passport number and country of issuance, or a notation in the record of the lack thereof. If the beneficiary's bank has knowledge that the person receiving the proceeds is not the beneficiary, the beneficiary's bank can obtain and retain a record of the beneficiary's name and address, as well as the beneficiary's taxpayer identification number (e.g., social security or employer identification number) or, if none, alien identification number or passport number and country of issuance, if known by the person receiving the proceeds, or a notation in the record of the lack thereof.

Some embodiments of the present invention can closely follow terms and definitions of applicable law. Accordingly, embodiments can include an acceptance occurring when a receiving Financial Institution, other than the recipient's Financial Institution, accepts a transmittal order by executing the transmittal order. A recipient's Financial Institution can accept a transmittal order for example, by paying the recipient, notifying the recipient of the receipt of the order or by otherwise becoming obligated to carry out the order. Embodiments can also include an RMC search being performed on informational data related to and/or descriptive of any person who transports, mails, ships or receives; is about to or attempts to transport, mail or ship; or causes the transportation, mailing, shipment or receipt of monetary instruments.

A monetary instrument can include, for example: currency; a traveler's check in any form; a negotiable instrument, including a personal check, business check, official bank check, cashier's check, third-party check, promissory note, and/or money order, any of which may be in bearer form, endorsed without restriction, made out to a fictitious payee, or otherwise in such form that title thereto passes upon delivery; an incomplete instrument, including a personal check, business check, official bank check, cashier's check, third-party check, promissory note; securities or stock in bearer form or otherwise in such form that title thereto passes upon delivery; or other form or vehicle which can act to transfer monetary value. In some forums a monetary instrument may not include a warehouse receipt or bill of lading, however such instruments can fall within the scope of this invention as it may be useful for Risk management to perform a RMC search information contained in any of the instruments listed routinely, periodically or upon request.

Some embodiments can also include currency defined as coin and paper money of the United States or of any other country that is designated as legal tender and that circulates and is customarily used and accepted as a medium of exchange in the country of issuance. Embodiments can therefore anticipate currency including U.S. silver certificates, U.S. notes and Federal Reserve notes. Currency can also include official foreign bank notes that are customarily used and accepted as a medium of exchange in a foreign country.

A beneficiary which, in some implementations, can be the subject of a RMC search can include a person to be paid by the beneficiary's bank, wherein the beneficiary's bank can include the bank or foreign bank identified in a payment order in which an account of the beneficiary is to be credited pursuant to an order or which otherwise is to make payment to the beneficiary if the order does not provide for payment to an account.

A transfer of funds can include a transaction, or series of transactions, which can begin with an originator's payment order, made for the purpose of making payment to a beneficiary of the order. Accordingly, any payment order issued by an originator's bank or an intermediary bank intended to carry out the originator's 103 payment order. A funds transfer is completed by acceptance by a beneficiary's bank of a payment order for the benefit of the beneficiary of the originator's 103 payment order. Also within the scope of this invention are any other funds transfer including those made through an automated clearinghouse, an automated teller machine, or a point-of-sale system.

An intermediary bank can include a receiving bank other than the originator's 103 bank or the recipient's 104 or beneficiary's 106 bank. Similarly, an intermediary Financial Institution can include a receiving Financial Institution, other than the transmittor's Financial Institution or the recipient's Financial Institution. The term intermediary Financial Institution can include an intermediary bank, both of which can be the subject of a RMC search.

An originator can include a sender of a first payment order in a funds transfer. An originator's bank can include a receiving bank to which a payment order of the originator is issued if the originator is not a bank or foreign bank, or the originator if the originator is a bank or foreign bank.

A payment order can include an instruction of a sender to a receiving bank, which can be transmitted orally, electronically, or in writing, to pay, or to cause another bank or foreign bank to pay, a fixed or determinable amount of money to a beneficiary such that the receiving bank is to be reimbursed by debiting an account of, or otherwise receiving payment from, a sender, and the instruction is transmitted by the sender directly to the receiving bank or to an agent, funds transfer system, or communication system for transmittal to the receiving bank.

A receiving bank can include a bank or foreign bank to which a sender's instruction is addressed. A receiving Financial Institution can include a Financial Institution or foreign financial agency to which the sender's instruction is addressed. The term receiving Financial Institution can include a receiving bank, or other receiving entity. A recipient can include a person to be paid by the recipient's Financial Institution, and can also include a beneficiary a recipient's Financial Institution can include a Financial Institution or foreign financial agency identified in a transmittal order in which an account of the recipient is to be credited pursuant to the transmittal order or which otherwise is to make payment to the recipient if the order does not provide for payment to an account. The term recipient's Financial Institution can, in some embodiments, include a beneficiary's bank.

A transaction can include any transfer of pecuniary value, including, for example, a purchase, sale, loan, pledge, gift, transfer, delivery, or other disposition, and with respect to a Financial Institution includes a deposit, withdrawal, transfer between accounts, exchange of currency, loan, extension of credit, purchase or sale of any stock, bond, certificate of deposit, or other monetary instrument or investment security, purchase or redemption of any money order, payment or order for any money remittance or transfer, or any other payment, transfer, or delivery by, through, or to a Financial Institution, by whatever means effected. Similarly, a “transaction in currency” can include a transaction involving the physical transfer of currency from one person to another.

A transmittal of funds can include a series of transactions beginning with a transmittor's transmittal order, made for the purpose of making payment to a recipient of the order. The term can include a transmittal order issued by a transmittor's Financial Institution or an intermediary Financial Institution intended to carry out the transmittor's transmittal order. The term transmittal of funds includes a funds transfer. A transmittal of funds can be completed by acceptance by the recipient's Financial Institution of a transmittal order for the benefit of the recipient of the transmittor's transmittal order. A transmittal order can include a payment order and is an instruction of a sender to a receiving Financial Institution, transmitted orally, electronically, or in writing, to pay, or cause another Financial Institution or foreign financial agency to pay, a fixed or determinable amount of money to a recipient. Typically an instruction will not state a condition to payment to the recipient other than time of payment and the receiving Financial Institution is to be reimbursed by debiting an account of, or otherwise receiving payment from, the sender.

A transmitter 103 can include an originator or other sender of a first transmittal order in a transmittal of funds. Typically, the term transmitter includes an originator. A transmittor's Financial Institution can include the receiving Financial Institution to which the transmittal order of the transmitter is issued if the transmittor is not a Financial Institution or foreign financial agency, or the transmittor if the transmittor is a Financial Institution or foreign financial agency. The term transmittor's Financial Institution includes an originator's bank, except where the originator is a transmittor's Financial Institution other than a bank or foreign bank.

An RMC system 108 can gather and receive information which may be related to risk variables in a financial transaction. Information may be received, for example, from publicly available sources, one or more subscribers 111, investigation entities, or other sources. The information is constantly updated and can be related to a financial transaction or an alert list in order to facilitate compliance with regulatory requirements. The RMC 108 facilitates due diligence on the part of a subscriber 111 by gathering, structuring and providing to the subscriber 111 data that relates to risk variables involved in a financial transaction.

A risk variable can be any data that can cause a risk level to change. A Financial Institution has an obligation to relate such variables to suspicious activity and also to know there customers. For example, a Financial Institution may need information on an individual who is a party to a transaction, or a corporation or other institutional entity that is involved in the transaction. Other risk variables can include for exemplary purposes, a sovereign state involved, a geographic area, a shell bank, correspondent account, a political figure, a person close to a political figure, a history of fraud, embargoes, sanctions, or other factors.

Risk variable related information can also be received from formalized lists, such as, for example: a list generated by the Office of Foreign Assets Control (OFAC) including their sanction and embargo list, a list generated by the U.S. Commerce Department, a list of international “kingpins” generated by the U.S. White House, foreign Counterpart list, U.S. regulatory actions or other information source such as a foreign government, U.S. adverse business-related media reports, U.S. state regulatory enforcement actions, international regulatory enforcement actions, international adverse business-related media reports, a list of politically connected individuals and military leaders, list of U.S. and international organized crime members and affiliates, a list put forth by the Financial Action Task Force (FATF), a list of recognized high risk countries, or other source of high risk variables. Court records or other references relating to fraud, bankruptcy, professional reprimand or a rescission of a right to practice, suspension from professional ranks, disbarment, prison records or other source of suspect behavior can also be an important source of information. Of additional interest can be information indicative that an entity is not high risk such as a list of corporations domiciled in a G-7 country, or a list of entities traded on a major exchange.

Risk variable related information can also include, artifacts, copies of artifacts, or a description of artifacts with content related to the risk variable. For example, an informational artifact can include a copy of a list generated by a government or regulatory entity, such as an OFAC list, or a FATF list, or a copy of a news article, court record, etc.

A Financial Institution can integrate a RMC system 108 to be part of legal and regulatory oversight for various due diligence and “know your customer” obligations imposed by regulatory authorities. The RMC 108 can facilitate detection and reporting of potential violations of law, and in one embodiment, address the “suitability” of a financial transaction and/or the assessment of sophistication of a customer. Similarly, the RMC 108 can support a Financial Institution's effort to meet requirements regarding the maintenance of accurate books and records relating to their financial transactions and affirmative duty to disclose material issues affecting an investor's decisions.

Various data scrubbing routines can be utilized to facilitate aggregation of risk variable related information. The routines can include programs capable of correcting a specific type of mistake, such as an incomprehensible address, or clean up a full spectrum of commonly found database flaws, such as field alignment that can pick up misplaced data and move it to a correct field or removing inconsistencies and inaccuracies from like data. Other scrubbing routines can be directed directly towards specific legal issues, such as money laundering or terrorist tracking activities.

For example, a scrubbing routine can be used to facilitate various different spelling of one name. In particular, spelling of names can be important when names have been translated from a foreign language into English. For example, some languages and alphabets, such as Arabic, have no vowels. Translations from Arabic to English can be very important for Financial Institutions seeking to be in compliance with lists supplied by the U.S. government that relate to terrorist activity and/or money laundering. A data scrubbing routine can facilitate risk variable searching for multiple spellings of an equivalent name or other important information. Such a routine can enhance the value of the aggregate data gathered and also help correct database flaws. Scrubbing routines can improve and expand data quality more efficiently than manual mending and also allow a subscriber 111 to quantify best practices for regulatory purposes.

Data aggregated into an RMC 108 can also be augmented to further facilitate rigorous risk management. Augmenting data can include data mining techniques that utilize software to analyze and sift through the aggregated data stored in an RMC 108 and implement techniques such as mathematical modeling, statistical analysis, pattern recognition, rule based trends or other data analysis tools. Embodiments that implement augmenting techniques can provide risk related searching with an added discovery dimension and return results that a human operator may find labor and cognitively intense.

Discovery dimensions can include the extraction of implicit, previously unknown and potentially useful information from the aggregated RMC 108 data. This type of extraction can include unlooked for correlations, patterns or trends. Other techniques that can be applied can include fuzzy logic and/or inductive reasoning tools.

Augmenting routines can therefore include enhancing available data with routines designed to reveal hidden data. Revealing hidden data or adding data fields derived from existing data can be very useful to risk management. For example, supplied data may not include an address for a person wishing to perform a particular fund transfer, or the address may be invalid; however a known telephone number may be available. Augmenting data can include associating the telephone number with a known geographic area or jurisdiction. The geographic area may be a political boundary, or coordinates, such as longitude and latitude coordinates, or global positioning coordinates. The geographic area identified can then be qualified as a high risk or low risk variable.

An additional example of augmented data derived from a telephone number can include associating a given telephone number with a high risk entity, such as a person listed on an OFAC list.

Embodiments can also include an alert list containing names and/or terms of interest relating to a wire transfer or electronic fund transfer supplied to a RMC 108. For, example a list can be customized and specific to a particular Originator 103 or Recipient 104, or for any connection to a particular jurisdiction, such as, for example, a country on an embargo list published by OFAC. The RMC 108 can continually monitor data in its database via an alert query with key word, fuzzy logic or other search algorithms and transmit related informational data to the interested party. In this manner, ongoing diligence can be conducted. In the event that new information is uncovered by an alert query, the Funds Transfer Provider 107, or other designated entity, can be immediately notified, or notified according to a predetermined schedule. Appropriate action can be taken according to the information uncovered.

The RMC 108 can quantify risk due diligence relating to a wire transfer or other electronic fund transfer by capturing and storing a record of information received, search results and actions taken. Once quantified, the due diligence data can be utilized for presentation, as appropriate, to regulatory bodies, shareholders, news media and/or other interested parties. Such presentation may be useful to mitigate adverse effects relating to a problematic transaction by demonstrating that corporate governance is being addressed through tangible risk management processes.

In some embodiments, a RMC can convey only information collected from publicly-available sources relevant for the detection and prevention of money laundering, fraud, corrupt practices, organized crime, activities subject to governmental sanctions or embargoes, or other similar activities that are the subject of national and/or global regulation.

Typically, a Funds Transfer Provider 107, or other party involved in a wire transfer or other automated or electronic funds transfer, can access a RMC 108 electronically and to, receives relevant information electronically. However, in specific circumstances, hard copy format or other vehicle may be utilized. Search inquiries presented to an RMC 108 can be accomplished via an electronic link that enables system to system inquires including single or batch screening requests, individual inquiries (submitted electronically, by facsimile, or by phone) for smaller screening requests, or through a web-based interface supporting an individual look-up service. Any other forum for conveying information, such as a wide area network, peer to peer network, wireless communication or other mechanism is also within the scope of this invention.

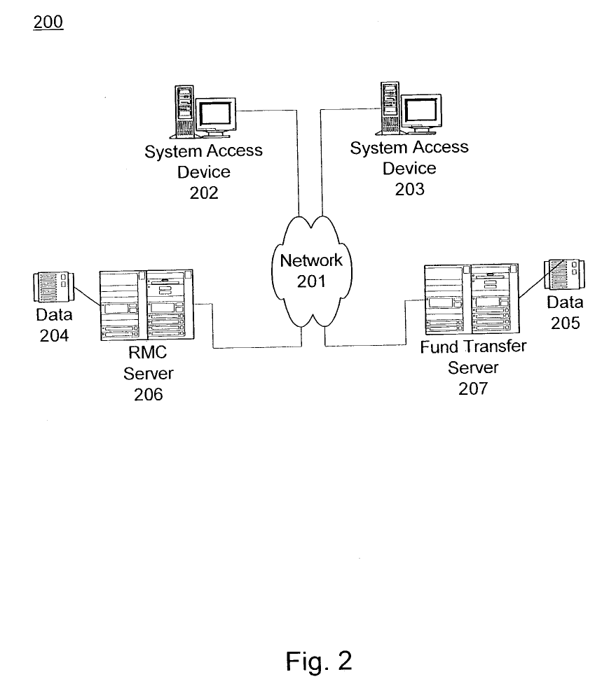

Referring now to FIG. 2, a network diagram illustrating one embodiment of the present invention is shown 200. An automated RMC system 108 can include a computerized RMC server 206 accessible via a distributed network 201 such as the Internet, or a private network. A transfer participant 103-104, can use a computerized system or network access device 202-203 to receive, input, transmit or view information processed in the RMC server 206. A protocol, such as the transmission control protocol internet protocol (TCP/IP) can be utilized to provide consistency and reliability.

A system access device 202-203 used to access the RMC server 206 can include a processor, memory and a user input device, such as a keyboard and/or mouse, and a user output device, such as a display screen and/or printer. Embodiments can include also a system access device 202-203 incorporated into a funds transfer or other banking system. A system access device 202-203 may interact with an RMC server 206 as if an RMC server 206 were a single entity in the network 200. However, the RMC server 206 may include multiple processing and database sub-systems, such as cooperative or redundant processing and/or database servers that can be geographically dispersed throughout the network 200.

The RMC server 206 can include one or more databases 204-205 storing data relating to risk management, and in particular to wire transfers or other electronic transfer of funds. The RMC server 206 may interact with and/or gather data from an operator of a system access device 202-203 or other source.

Interaction with a system access device 202-203 can be accomplished via software executed at a system access device 202-203. Such software may include a any programming language, such as a generic hypertext markup language (HTML) browser. Embodiments can also include an executable program, such as a Java™ program which can be executed at the system access device 202-203 as part of RMC software. Other implementations include proprietary software installed from a computer readable medium, such as a CD ROM. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

Information relating to wire transfer jurisdictions can be aggregated into a searchable data storage structure 204. Aggregating data into a data structure 204, such as a data warehouse, allows a RMC server 206, or other system device, to have such data 204 readily available for processing a risk management search associated with a transfer of funds. Aggregated data 204 can also be scrubbed or otherwise enhanced to aid in searching.

Embodiments can include data scrubbing to enhance data included in a data base 204. Data scrubbing can be utilized to store information in a manner that gives faster, easier and/or more flexible access to pertinent aspects of the data.

Embodiments can include receiving wire transfer information 105 from a Financial Institution 101-102 in any form that can accurately convey information necessary to complete the transfer of funds. For example, information can be input into a graphical user interface (GUI), submitted via hard copy, facsimile, scanned image, or any other form of information conveyance.

Various data scrubbing routines can be utilized to facilitate aggregation of risk variable related information. The routines can include programs capable of correcting a specific type of mistake, such as an incomprehensible address, or clean up a full spectrum of commonly found database flaws, such as field alignment that can pick up misplaced data and move it to a correct field or removing inconsistencies and inaccuracies from like data. Other scrubbing routines can be directed directly towards specific legal issues, such as money laundering or terrorist tracking activities.

For example, a scrubbing routine can be used to facilitate various different spellings of one name. In particular, spelling of names can be important when names have been translated from a foreign language into English. A data scrubbing routine can facilitate risk variable searching for multiple spellings of an equivalent name or other important information. Such a routine can enhance the value of the aggregated data 204 and also help correct database 204 flaws.

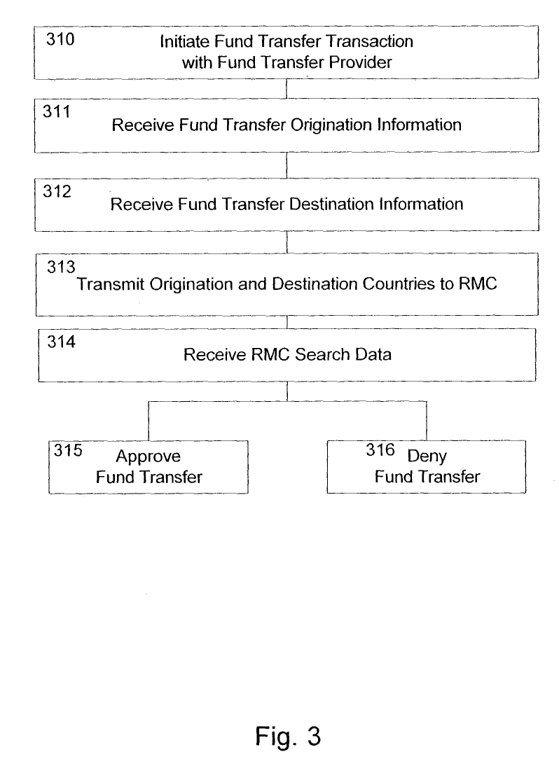

Referring now to FIG. 3, steps that can be performed from the perspective of a Funds Transfer Provider 107, while practicing various embodiments of the present invention are illustrated. A fund transfer transaction can be initiated 310 with a Funds Transfer Provider 107. The funds transfer transaction can be initiated, for example, by a Financial Institution 101-102 at the request of a fund transfer originator 103. Information relating to origination of a fund transfer a can be received 311. The information relating to the origination of the fund transfer can be descriptive of, and relate to the originator, accounts, entities involved, and other information as previously described above. In addition, information relating to a fund transfer destination, recipient, beneficiary and other related information can also be received 312. Information transmitted to the Funds Transfer Provider 107 can include a designation of an origination country, intermediary country and destination country 313. The RMC 108 can perform an RMC search and provide the results to the Funds Transfer Provider 107. The Funds Transfer Provider 107 can receive the RMC search data and utilize the RMC search data to facilitate a decision on whether to approve the fund transfer 315 or deny the fund transfer 316.

Referring now to FIG. 4, additional aspects of the present invention that can be practiced in some embodiments of the invention can include a RMC system 108 receiving fund transfer origination information 410 and associating a unique RMC identifier with the originator 411. In addition, the RMC 108 can receive fund transfer destination information 412 which can include information relating to a recipient, beneficiary or other related entity and information as further described above. Accordingly, a unique RMC identifier can be associated with a destination, recipient or beneficiary 413.

A funds transfer transaction can be initiated with a funds transfer provider 414 and risk query information inclusive of the unique RMC identifiers can be transmitted 415 to the RMC 108. The RMC 108 can perform a risk variable search and return the results to the Financial Institution. The Financial Institution can receive the RMC search data 416 and utilize the RMC search results to facilitate a decision on whether to approve a fund transfer 417, deny a funds transfer and/or issue a SAR 419.

Unique RMC identifiers can be anonymous to a RMC 108 in the sense that the RMC 108 does not need to be notified of the identity of a person or entity associated with the unique RMC identifier. However, a RMC 108 can monitor activity associated with a particular unique identifier. Monitoring of a unique identifier can be accomplished across multiple fund transfer transactions, across Financial Institutions 101-102, for a set period of time, for a threshold of fund transfer activity, for patterns of transfers to or from a particular entity, or for some other pattern or criteria.

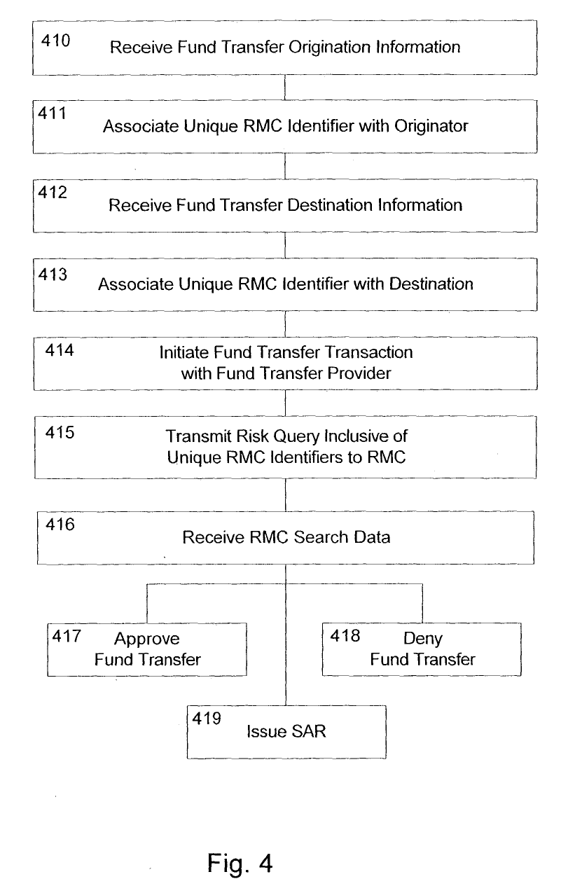

Referring now to FIG. 5, a data structure that can be utilized in some implementations of the present invention is illustrated. A wire transfer or other electronic transfer of funds can include data fields associated with: a Transaction Participant name 510; Transaction Participant address 511, Beneficiary 512; Transaction Participant tax payer identification 513; type of Transaction Participant identification document 514; country of issuance of I.D. document 515; Transaction Participant citizenship 516; Recipient 517; origination jurisdiction 518; intermediary jurisdiction 519; destination jurisdiction 520; recipient related data 521; or any other data field necessary or related to the fund transfer process.

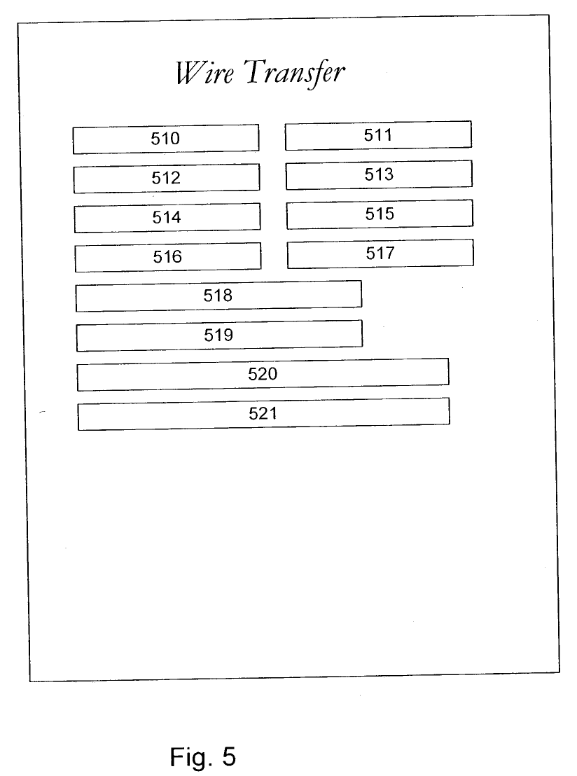

Referring now to FIG. 6, steps that can be implemented by a RMC system 108 in various embodiments of the present invention are illustrated. A RMC 108 can receive information relating to a wire transfer or other electronic payment 610. The RMC 108 can search risk variables associated with the wire transfer, including any jurisdictions that may be involved in the transaction 611. Embodiments can also include calculating a risk quotient related to the wire transfer 612. The risk quotient can be a qualitative value indicative of an amount of risk associated with a wire transfer. The RMC 108 can transmit the risk quotient and any search results to a requestor of the RMC search 613.

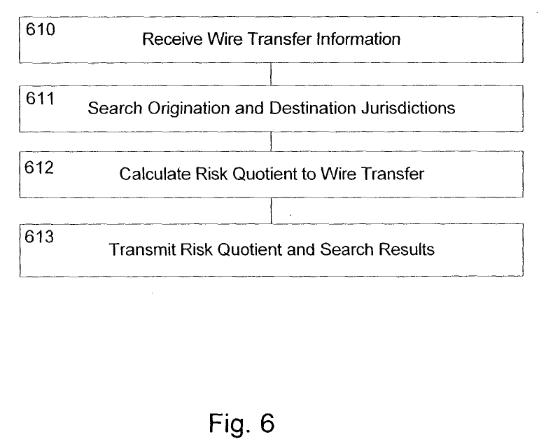

Referring now to FIG. 7, an exemplary GUI 700 that can be utilized while practicing some embodiments of the present invention is illustrated. A portion of a display 700 can display information that relates to an originator, transmitter or other initiator of a wire transfer 701, such as data described in detail above. Another portion of the display can include a description of a recipient 702 and any intermediaries 703. Still another portion can contain information relating to jurisdictions involved 704.

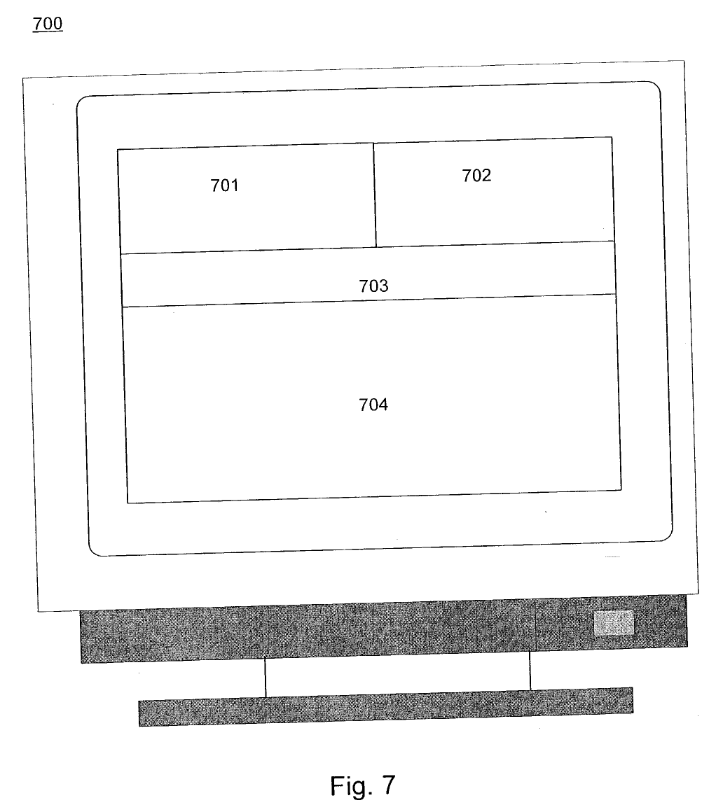

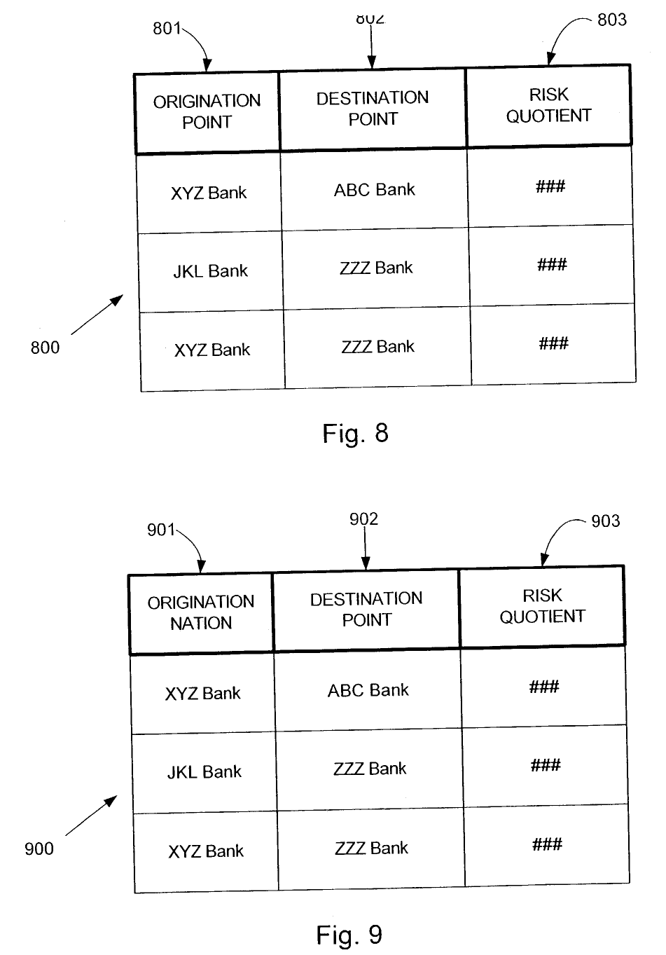

Referring now to FIGS. 8 and 9, portions of a database that can be utilized while implementing embodiments of the present invention are illustrated. A portion of a database 800 can include data fields for an origination point 801, a destination point 802 and a risk quotient 803. In addition, another database portion 900 can include an origination nation a destination point 902 and a risk quotient 903.

A number of embodiments of the present invention have been described. Nevertheless, it will be understood that various modifications may be made without departing from the spirit and scope of the invention. For example, a fund transmittal can include “due from” and “due to” transactions which can utilize correspondent accounts or journal entry transfers to transfer funds. Still other embodiments include a multi-party or pooled transfer from one Financial Institution to another institution. Accordingly, other embodiments are within the scope of the following claims.

What is claimed is:

1. A computer-implemented method for managing risk related to transfer of funds, the method comprising:
indicating in a computer system that a person is a transaction participant according to the person's status as at least one of: a transaction originator; a transaction intermediary, a transaction recipient or a transaction beneficiary;
gathering data into the computer system generally related to one or more risk variables;
receiving data into the computer system relating details of a financial transaction wherein the data received comprises identification data for at least one transaction participant;
structuring the received data generally related to one or more risk variables according to risk criteria, wherein the risk criteria comprise at least one of: a position held by the transaction participant; a country in which the position is held; how long the position has been held; the veracity of previous dealings with persons from the country in which the position is held; the propensity of people in similar positions to execute unlawful transactions; the propensity of people in similar positions to execute unethical transactions; inclusion of the participant on a list indicating elevated risk; and the type of account; and
generating a report relating to risk due diligence wherein the report comprises an indication that the transaction participant is associated with elevated risk and at least some of the structured data.

2. The method of claim 1 wherein the gathered data is gathered exclusively from publicly available sources.

3. The method of claim 1 wherein the indication that a person is a transaction participant is received as a result of a system to system inquiry involving batch screening requests.

4. The method of claim 1 wherein the indication that a person is a transaction participant is received electronically.

5. The method of claim 1 wherein the indication that a person is a transaction participant is received via facsimile.

6. The method of claim 1 wherein the indication that a person is a transaction participant is received via voice communication.

7. The method of claim 1 wherein the transaction participant comprises a beneficiary to a wire transfer.

8. The method of claim 1 wherein the transaction participant comprises a originator of a wire transfer.

9. The method of claim 1 wherein the inquiry relating to a transfer of funds comprises a recipient of a wire transfer.

10. A method for managing risk associated with implementing an electronic transfer of funds, the method comprising:
receiving information descriptive of a originator of an electronic funds transfer;
receiving information descriptive of a recipient of the electronic funds transfer;
transmitting the information descriptive of the originator and recipient of the funds transfer to a risk management clearinghouse; and
receiving results of a risk management clearinghouse search.

11. The method of claim 10 wherein the results of the risk management clearinghouse search comprises a risk quotient.

12. The method of claim 10 wherein the results of the risk management clearinghouse search comprises a reference to an OFAC list.

13. The method of claim 10 wherein the results of the risk management clearinghouse search comprises a reference to an FATF list.

14. The method of claim 10 wherein the gathered data related relevant to regulation accurately reports on or consists of a governmental record.

15. The method of claim 10 additionally comprising the step of receiving copies of source documents relevant to the risk management clearinghouse search results.

16. A computer-implemented method for managing risk, the method comprising:
gathering data relevant to transaction participants in an electronic fund transfer;
aggregating the data gathered according to risk variables;
receiving an inquiry relating to a transaction participant in an electronic transfer of funds;
associating portions of the aggregated data with the transaction participant; and
transmitting the associated portions of the aggregated data.

17. The method of claim 16 wherein the inquiry comprises an originator of the electronic transfer of funds.

18. The method of claim 16 additionally comprising the step of generating a report relating to a financial institution's obligation to know their customer, wherein the report comprises the inquiry and the associated portions of the aggregated data.

19. The method of claim 16 additionally comprising the step of generating a report facilitating the filing of a suspicious activity report.

20. The method of claim 16 wherein the participant comprises details descriptive of a beneficiary of the wire transfer.

21. The method of claim 16 wherein the risk subject comprises jurisdictions involved in a wire transfer.

22. The method of claim 16 wherein the inquiry relating to a transaction participant comprises an alert list.

23. The method of claim 16 additionally comprising the steps of receiving a source of gathered data and transmitting the source of the associated portions of aggregated data.

24. The method of claim 16 additionally comprising the step of enhancing the gathered data.

25. The method of claim 16 additionally comprising the step of enhancing the data descriptive of the risk variable.

26. The method of claim 16 wherein enhancing the data comprises scrubbing the data to incorporate changes in the spelling of a risk variable.

27. A computerized system for managing risk, the system comprising:
a computer server accessible with a system access device via a communications network; and
executable software stored on the server and executable on demand, the software operative with the server to cause the system to:
gather data relevant to transaction participants in an electronic fund transfer;
aggregate the data gathered according to risk variables;
receive an inquiry relating to a transaction participant in an electronic transfer of funds;
associate portions of the aggregated data with the transaction participant; and transmit the associated portions of the aggregated data.

28. The computerized system of claim 27 wherein the data is gathered via an electronic feed.

29. Computer executable program code residing on a computer-readable medium, the program code comprising instructions for causing the computer to:
gather data relevant to transaction participants in an electronic fund transfer;
aggregate the data gathered according to risk variables;
receive an inquiry relating to a transaction participant in an electronic transfer of funds;
associate portions of the aggregated data with the transaction participant; and
transmit the associated portions of the aggregated data.

30. A computer data signal embodied in a digital data stream comprising data relating to risk management, wherein the computer data signal is generated by a method comprising the steps of:
gathering data relevant to participants of an electronic fund transfer risk;
aggregating the data gathered according to risk variables;
receiving an inquiry relating to at least one participant in an electronic transfer of funds;
associating portions of the aggregated data with the at least one participant in an electronic transfer of funds; and
transmitting the associated portions of the aggregated data.
